(19) United States
(12) Patent Application Publication
(10) Pub. No.: US 2020/0060334 A1
(43) Pub. Date: Feb. 27, 2020

(54) Hand-held Display Case

(71) Applicant: Jonathon McCrae, Lauderdale Lakes, FL (US)

(72) Inventor: Jonathon McCrae, Lauderdale Lakes, FL (US)

(21) Appl. No.: 16/110,695

(22) Filed: Aug. 23, 2018

(51) Int. Cl. A24F 15/12; B65D 25/04; B65D 25/54; B65D 85/00

(52) U.S. Cl. CPC A24F 15/12; B65D 25/04; G06Q 30/0185; B65D 85/70; B65D 25/54

(57) ABSTRACT

The subject application relates to an enclosure for the display and preservation of various forms and/or strains of substances, controlled substances or medicinal and recreational herbs, and the collecting and trading thereof. The enclosure is comprised of an upper and a lower portion, and a seal between the upper and lower portion. The lower portion consists of a plurality of compartments, each compartment designed to contain at least one of each of a specific solid, a liquid, or an amorphous solid form of the substance. The ideal embodiment of the upper portion is a clear housing that facilitates the viewing of the substances within the enclosure compartments, and displays them in an aesthetically pleasing manner, which also has slightly beveled compartments symmetrical to the compartments on the bottom portion of the enclosure. The upper and lower portions are sealed to ensure an airtight fit and to prevent degradation of the substances within. Additionally, means to validate the contents of the substance, and means for automatic identification and/or data capture is taught.

### BACKGROUND OF THE INVENTION

This present invention broadly relates to a concept of collecting and trading specific forms of a cannabis substance including but not limited to a specific solid, liquid, cream, and/or an amorphous solid form of a cannabis substance, using a hand-held enclosure. By utilizing this hand-held enclosure for various strains, a connoisseur of medicinal or recreational herbs can now start to collect and trade those various strains and utilize the enclosure for gaming.

Medicinal and recreational herbs, since its legalization is certain states, has been widely used and contained in many ways. For example, smoking it, eating it, and using as a form of topical applicant for pain relief. In addition, forms of containment have been widely marketed for concealment, transport, and displaying. When considering other variations of containment that are suitable for collecting medicinal and recreational herbs, they do not provide a means for collecting numerous enclosures and/or trading numerous enclosures, nor do they provide containment which compresses and limits the movement of the specific forms of a cannabis substance, nor do they provide a gaming apparatus, which incorporates online gaming for connoisseurs to compete for an enclosure to build a collection.

A similar concept of this invention would be trading cards, for example sports related trading cards, that have a picture of an athlete along with biographical and statistical information about the athlete. These cards are used by sports enthusiasts to obtain cards that are needed to complete a set of related cards or to collect cards that are not readily available. Regarding the invention, collectors can buy, collect, and trade these hand-held enclosures for their economic and historic value. The enclosure themselves have varying monetary values, depending on the popularity of the individual strains thereon and the availability of each enclosure, some being more common than others, but controllable using this invention. Such enclosures are typically sold through marijuana dispensaries. This present invention has the capability to store information about the contents within the enclosure by means of a barcode that is placed on the enclosure so that any user can retrieve the information instantly. In addition, this information will enable the user to participate in a game, which when played between two opponents, it allows the user to obtain points to increase the user's status.

U.S. Pat. No. 6,623,010 of Warren L. Holland Jr. describes a method for forming a card deck from a larger number of cards. A player my potentially collect hundreds of collectible cards. As the number of collectible cards increases, so does the complexity of the card game. Further, a player having substantially more collectible cards than an opposing player may be at a substantial advantage over that opposing player. however, this method of collecting cards does not provide a method of collecting nor trading medical or recreational herbs within an enclosure.

U.S. Pat. No. 20170112181 of John Belfance, Kasey Myers, Ethan Ross Perdue, William Frederick Spano, Jonathon Freedman, and Franklin Lee Lucas, J R provides an invention that relates to methods for storing and preserving cannabis or cannabis-containing substances using container assemblies, but does not provide a concept of collecting and trading, nor do they provide containment which compresses and limits the movement of the specific forms of a cannabis substance.

U.S. Pat. No. 5,836,474 of Georan Wessberg describes an invention that relates to a medicament storage device which includes a storage plate having a plurality of storage spaces for storing quantities, such as medicament dosages and a base unit which has a memory and an alarm function, but does not provide a concept of collecting and trading, nor do they provide containment which compresses and limits the movement of a specific solid, a liquid, or an amorphous solid form of a cannabis substance.

U.S. Pat. No. 20160107796 of David P. Sibley describes an application that provides a container for storage, preservation, identification, tracking and transport of a federally controlled substance comprising a one or more-piece airtight container having an exterior surface and an interior surface, an upper portion and a lower portion, configured for containing a federally controlled substance, yet it does not provide a concept of collecting and trading of that controlled substance, nor do they provide containment which compresses and limits the movement of the specific forms of a cannabis substance.

### BRIEF SUMMARY OF THE INVENTION

invention relates broadly to an apparatus to promote a connoisseur of medicinal or recreational herbs to facilitate the displaying, the collecting, and the trading of a multiplicity of enclosures, each containing positively identifiable strains of substances contained within the enclosures. Additionally, means to tag the enclosure and validate the contents of the substance within, by means for automatic identification and/or data capture is taught, by means of Barcoding, QR Coding, an RFID chip, sticker or other means well known to those in the art of product ID tagging. This tag would provide the end user with an additional level of verification of that of which is proposed to be in that enclosure is what's within that enclosure, giving users of medicinal and recreational herbs a greater level of assurance that the product meets their expectation. In addition, this information will enable the user to participate in a game, which when played between two opponents, it allows the user to obtain points to increase their status. Also, based on a dispensaries demand or promotion for certain strains, the product is assigned a design feature to be uploaded in the database and showcase on the enclosure.

### BRIEF DESCRIPTION OF THE DRAWINGS

FIG. 1 is an exploded view of the enclosure, containing for example, at least one of each of a specific solid, a liquid, and an amorphous solid form of a substance in the enclosed compartments.

FIG. 2 is the right-side view of the enclosure assembled.

FIG. 3 depicts FIG. 2, with each compartment containing for example, at least one of each of a specific solid, a liquid, or an amorphous solid form of a cannabis substance in the enclosed compartments.

FIG. 4 is a side view of the enclosure assembled, showing the length of the enclosure.

FIG. 5 is a top and bottom view, showing the width of the enclosure.

FIG. 6 is a left-side view of the enclosure, showing at least two compartments containing for example, at least one of each specific solid, a liquid, or an amorphous solid form of a substance.

FIG. 7 is a right-side view of the enclosure, showing at least one compartment containing for example, at least one of each specific solid, a liquid, and an amorphous solid form of a cannabis substance.

### DETAILED DESCRIPTION OF THE INVENTION

The various embodiments and variations thereof illustrated in the accompanying figures and/or described herein are merely exemplary and are not meant to limit the scope of the invention. It is to be appreciated that numerous variations of the invention have been contemplated as would be obvious to one of ordinary skill in art with the benefit of this disclosure. Rather, the scope and breadth afforded this document should only be limited by the claims provided herein while applying either the obvious meaning to each of the terms and phrases in the claims or the meaning clearly and unambiguously provided in this specification.

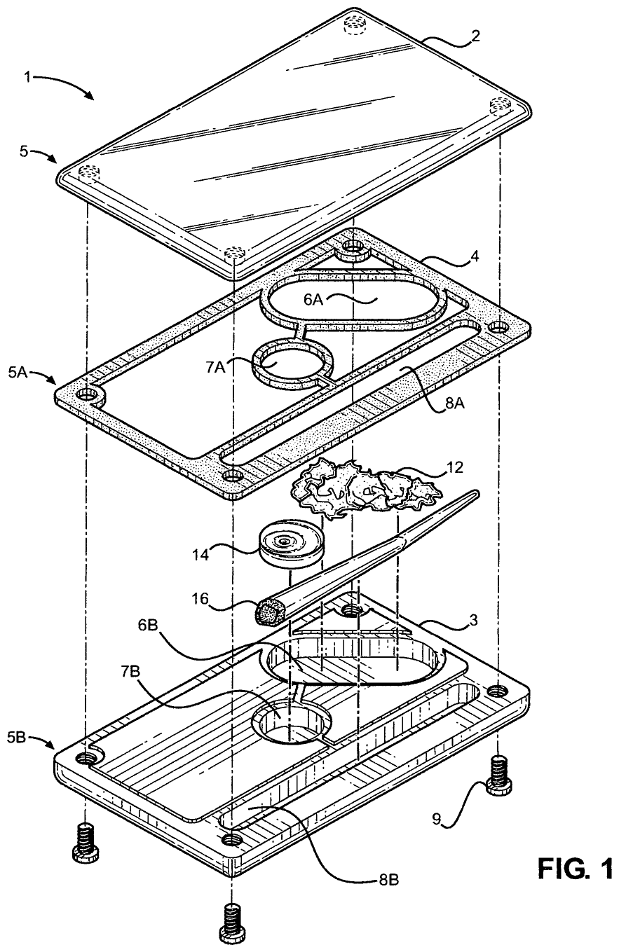

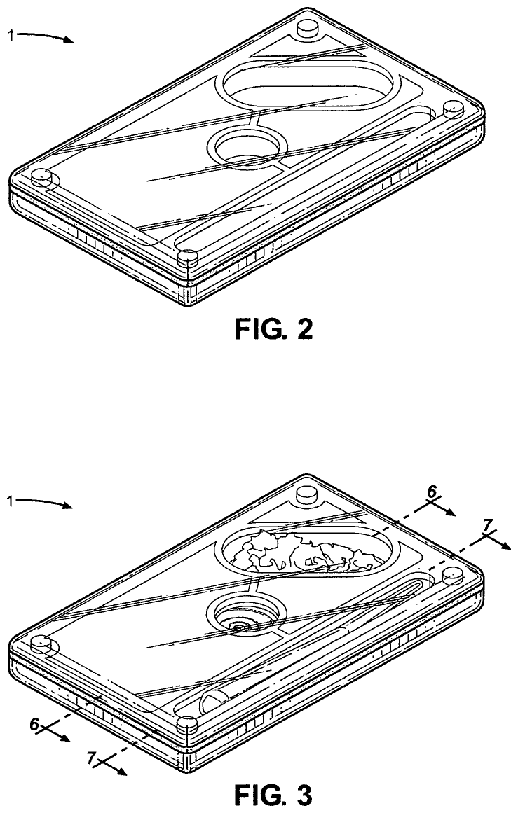

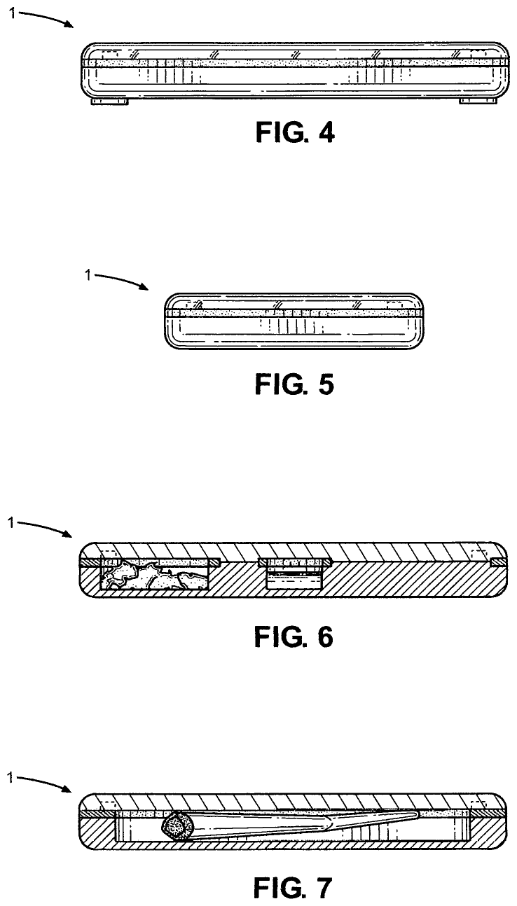

The embodiment of the enclosure 1 is illustrated in FIG. 1. Referring to FIG. 1, in this embodiment, the top portion 2 which is clear and allows for viewing the contents. The bottom portion 3 having three compartments 6b,7b and 8b containing as shown, medicinal or recreational herbs 12, waxy 14 and joint 16 forms of a cannabis substance. In between the top and bottom portions is a seal 4, with sections 6a, 7a and 8a symmetrical with the bottom portion compartments 6b, 7b and 8b. The enclosure is secured with screws 9 to completely fasten the top portion 2, the seal 4 and the bottom portion 3 providing an airtight seal enclosure. Referring to FIG. 2, the enclosure 1, is assembled and depicted. Referring to FIG. 3, the enclosure 1, is assembled with each compartment containing at least one of each of a specific solid, a liquid, or an amorphous solid form of a cannabis substance in the enclosed compartments. Referring to FIG. 4, the enclosure 1, is assembled and is depicting a side view of the length. Referring to FIG. 5, the enclosure 1, is assembled and is depicting a top and/or bottom view of the width. Referring to FIG. 6, the enclosure 1, is assembled and is depicting a left side view, showing at least two compartments containing at least one of each specific solid, a liquid, or an amorphous solid form of a substance. Referring to FIG. 7, the enclosure 1, depicts a right-side view showing at least one compartment containing at least one of each specific solid, a liquid, or an amorphous solid form of a substance. The invention of the cannabis display case 1 sole purpose is to collect and trade medicinal and recreational cannabis related substances and is designed to fit in the palm of the hand.

The invention, a hand-held cannabis case for preserving, collecting and trading, a multiplicity of forms of cannabis, comprised of:

1: An enclosure consisting of a top portion, a bottom portion, and a seal between the top and bottom portions to provide an airtight seal to the contents within the enclosure, with the top and bottom portions being bonded together by the seal and screws.
Whereas, the top portion of the enclosure is clear or has a clear portion allowing for viewing the contents of the enclosure and has beveled compartments symmetrical to the bottom portion of the enclosure to maximize containment,
Whereas, the seal of the enclosure
Whereas, the bottom portion of the enclosure has at least two compartments to separate the contents of the enclosure into at least two discrete areas within the enclosure,
Whereas, the contents within the enclosure consists of at least two forms of either a solid form of the substance, a waxy or crystalline amorphous solid form of the substance, and a liquid form of the substance.

2: according to claim 1, an enclosure that is displaced of air and sealed to be airtight.

3: according to claim 1, an enclosure having an airtight seal between the top and bottom portions of the enclosure, which is displaced of air and sealed to be airtight.

4: according to claim 1, an enclosure that has an airtight seal between the top and bottom portions of the enclosure, which is displaced of air and filled with an inert gas, and sealed to be airtight.

5: according to claim 1, an enclosure that has an airtight seal between the top and bottom portions of the enclosure, which provides containment that compresses and limits the movement of the specific forms of a cannabis substance.

6: according to claim 1, an enclosure that has an airtight seal between the top and bottom portions of the enclosure, which the top and bottom portions are bonded together.

7: according to claim 1, an enclosure that has an airtight seal between the top and bottom portions of the enclosure, which the top and bottom portions and the seal are bonded together by screws.

8: according to claim 1, an enclosure designed with a multiplicity of compartment containing the many forms of a cannabis substance.
